(19) United States
(12) Patent Application Publication
(10) Pub. No.: US 2006/0189789 A1
(43) Pub. Date: Aug. 24, 2006

(54) Method for treating recycled polyethylene terephthalate

(76) Inventors: Donald W. Hayward, Waterville, OH (US); Daniel L. Witham, Holland, OH (US)

Correspondence Address: FRASER MARTIN & MILLER LLC, 28366 KENSINGTON LANE, PERRYSBURG, OH, 43551, US

(21) Appl. No.: 10/550,246

(22) PCT Filed: Mar. 12, 2004
(86) PCT No.: PCT/US04/07955

§ 371 Date: Sep. 23, 2005

Related U.S. Application Data
(60) Provisional application No. 60/459,904, filed on Apr. 2, 2003.

(51) Int. Cl. C08F 6/00

(52) U.S. Cl. 528/502 R

(57) ABSTRACT

A process for treating RPET flakes comprises providing a quantity of RPET flakes, comminuting the RPET flakes to prepare RPET particles having an average mean particle size less than about 300 microns, and treating the RPET particles utilizing a low energy process selected from the group consisting of simultaneously melting and mixing the RPET particles by means of a low energy melting device to prepare an RPET melt, and thermally treating the RPET particles to dry or crystallize the RPET particles.

### CROSS REFERENCE TO RELATED APPLICATION

This Application claims the benefit of U.S. Provisional Patent Application Ser. No. 60/459,904 filed on Apr. 2, 2003.

### FIELD OF THE INVENTION

This invention relates generally to an improved method for treating recycled polyethylene terephthalate (RPET). More particularly, the invention is directed to a method for treating RPET so that it can be melted utilizing low energy processing equipment or thermally treated more quickly with less energy.

### BACKGROUND OF THE INVENTION

Post-consumer processing of recycled PET to manufacture a variety of low-tech consumer products such as flower pots and fence posts is well-known. Typically, the recycling process utilizes used PET containers, such as discarded carbonated beverage containers, which are collected, sorted, washed, and separated from contaminants to yield a relatively clean source of RPET. Additionally, the manufacture of imperfect and damaged molded PET products, particularly the blow molded bottles used for containing consumer goods, results in a considerable amount of PET waste which the manufacturers of such products would like to reuse. The RPET produced by conventional recycling processes is generally in ground or flake form, which is thereafter melt processed or further pelletized by the end user.

RPET is generally subjected to a grinding operation in order to make the material easier to handle and process. Conventional grinding equipment reduces the RPET to about ⅜ inch particles or flakes. The grinding is conducted in a manner to insure that a consistent flake size will be produced, by employing a grate or screen through which the ground material must pass upon exiting the grinder. Although conventional RPET flakes melt processing and pelletizing equipment is designed to handle ⅜ inch flakes, some RPET materials having sizes as large as ½ inch and as small as ¼ inch are also commercially produced. The bulk density of ⅜ inch flake RPET generally ranges from about 22 to about 35 pounds per cubic foot.

Considerable post-processing of RPET is typically necessary for the manufacture of, for example, plastic containers. Many process systems and procedures have been devised to treat ⅜ inch RPET flakes. More specifically, the vast majority of extruders and extruder barrels and screws have been designed to feed, melt, mix, and meter ⅜ inch RPET flake feed stock. Other heat treating equipment such as, for example, crystallizers and dryers have likewise been designed to accept ⅜ inch RPET flakes. The operation of these devices, however, requires a great amount of energy and long processing times, to thermally treat, or prepare a polymer melt from, the industry standard ⅜ inch RPET flakes.

It would be desirable to thermally treat, or prepare a polymer melt from, recycled polyethylene terephthalate, utilizing low energy thermal processing and melting equipment.

### SUMMARY OF THE INVENTION

Accordant with the present invention, an improved process for thermally treating or preparing a melt from RPET, utilizing low energy processing equipment, has surprisingly been discovered. The process comprises providing a quantity of RPET flakes, comminuting the RPET flakes to prepare RPET particles having an average mean particle size less than about 300 microns, and treating the RPET particles utilizing a low energy process selected from the group consisting of simultaneously melting and mixing the RPET particles by means of a low energy melting device to prepare an RPET melt, and thermally treating the RPET particles to dry or crystallize the RPET particles.

The inventive process is particularly useful for treating RPET flakes for the subsequent processing and forming of, for example, plastic containers.

### DETAILED DESCRIPTION OF THE PREFERRED EMBODIMENT

The present invention is directed to a process for treating RPET flakes utilizing low energy processing equipment, comprising providing a quantity of RPET flakes, comminuting the RPET flakes to prepare. RPET particles having an average mean particle size less than about 300 microns, and treating the RPET particles utilizing a low energy process selected from the group consisting of simultaneously melting and mixing the RPET particles by means of a low energy melting device to prepare an RPET melt, and thermally treating the RPET particles to dry or crystallize the RPET particles.

By the term “RPET flakes” as it is used herein is meant generally the commercially available recycled polyethylene terephthalate materials produced by conventional polyethylene terephthalate recycling methods, usually in flake form, but which may additionally be in the form of chunks, spheres, pellets, and the like, and which are generally made available in bulk in a substantially uniform particle size from about ¼ inch to about ½ inch.

According to the present invention, a quantity of RPET flakes is provided for further processing. The quantity of RPET flakes provided in the initial step of the inventive process may easily be determined by a routineer in the art of polymer processing, depending upon the quantity of RPET ultimately desired.

According to the present invention, the RPET flakes are comminuted by any conventional means, to prepare RPET particles having an average mean particle size less than about 300 microns. Methods and apparatus for comminuting RPET and other polymers are well known in the art.

Following comminuting of the RPET flakes, the resultant RPET particles are treated, utilizing a low energy process. The low energy process may comprise either the preparation of an RPET melt or the thermal processing of the RPET particles to effect their drying and crystallization.

In the first alternative treatment step, the RPET particles are simultaneously melted and mixed utilizing conventional low energy equipment such as, for example, a 2-roll mill, a heated casting roll, a rotating mandrel to effect frictional melting, or the like. The resultant RPET polymer melt is beneficial for combining with other polymer materials for subsequent melt processing and forming operations. For example, the addition of the inventive RPET melt to a quantity of virgin polyethylene terephthalate (PET) will extend the volume of the virgin PET.

By contrast to the present invention, RPET flakes have formerly been processed utilizing large extruders having complicated screw designs to handle the ⅜ inch flake starting material. The present inventive process benefits from the much greater surface-to-volume ratio of the RPET particles (relative to the RPET flakes) to facilitate the melting and thorough mixing using low energy shear devices.

In the second alternative treatment step, the RPET particles are thermally treated to dry and/or crystallize same. This may be achieved by conventional means such as, for example, heating the mass of RPET particles to a temperature below the melt temperature of polyethylene terephthalate. This heating may be accomplished, for example, by passing a gas over or through the bed of RPET particles. Examples of useful gases include, but are not limited to, air, nitrogen, argon, and the like, as well as mixtures thereof.

By contrast to the present invention, RPET flakes have formerly been dried and/or crystallized in heated chambers for required periods of time up to about five hours. The present inventive process again benefits from the large surface-to-volume ratio of the RPET particles, to achieve the same levels of dryness and/or crystallinity in approximately fifteen minutes; thus requiring less energy and time to accomplish the same result.

The process for treating RPET flakes utilizing low energy processing equipment described hereinabove is generally disclosed in terms of its broadest application to the practice of the present invention occasionally, the process conditions as described may not be precisely applicable to each RPET flake and low energy process combination included within the disclosed scope. Those instances where this occurs, however, will be readily recognized by those ordinarily skilled in the art. In all such cases, the process may be successfully performed by conventional modifications to the disclosed method.

The invention is more easily comprehended by reference to specific embodiments recited hereinabove which are representative of the invention. It must be understood, however, that the specific embodiments are provided only for the purpose of illustration, and that the invention may be practiced otherwise than as specifically illustrated without departing from its spirit and scope.

What is claimed is:

1. A process for treating RPET flakes, comprising:
providing a quantity of RPET flakes;
comminuting the RPET flakes, to prepare RPET particles having an average mean particle size less than about 300 microns; and
treating the RPET particles utilizing a low energy process selected from the group consisting of simultaneously melting and mixing the RPET particles by means of a low energy melting device to prepare an RPET melt, and thermally treating the RPET particles to dry or crystallize the RPET particles.

2. The process for treating RPET flakes according to claim 1, wherein the RPET flakes comprise chunks, spheres, pellets, or mixtures thereof.

3. The process for treating RPET flakes according to claim 1, wherein the RPET flakes have particle sizes from about ¼ inch to about ½ inch.

4. The process for treating RPET flakes according to claim 1, wherein the simultaneous melting and mixing step is accomplished using a low energy melting device selected from the group consisting of a 2-roll mill, a heated casting roll, and a rotating mandrel.

5. The process for treating RPET flakes according to claim 1, wherein the thermal treating step is accomplished by heating the RPET particles to a temperature below the melt temperature of polyethylene terephthalate.

6. The process for treating RPET flakes according to claim 5, wherein the RPET particles are heated by passing a gas over or through the bed of RPET particles.

7. The process for treating RPET flakes according to claim 6, wherein the gas comprises air, nitrogen, argon, or mixtures thereof.

8. A process for treating RPET flakes, comprising:
providing a quantity of RPET flakes, comprising chunks, spheres, pellets, or mixtures thereof, having particle sizes from about ¼ inch to about ½ inch;
comminuting the RPET flakes, to prepare RPET particles having an average mean particle size less than about 300 microns; and
treating the RPET particles utilizing a low energy process selected from the group consisting of simultaneously melting and mixing the RPET particles by means of a low energy melting device selected from the group consisting of a 2-roll mill, a heated casting roll, and a rotating mandrel, to prepare an RPET melt, and thermally treating the RPET particles by heating the RPET particles to a temperature below the melt temperature of polyethylene terephthalate by passing a gas comprising air, nitrogen, argon, or mixtures thereof over or through the bed of RPET particles, to dry or crystallize the RPET particles.
